(19) United States
(12) Patent Application Publication
(10) Pub. No.: US 2018/0155098 A1
(43) Pub. Date: Jun. 7, 2018

(54) Locking Case for Electronic Devices

(71) Applicant: Fatihi Agbaje, Roswell, GA (US)

(72) Inventor: Fatihi Agbaje, Roswell, GA (US)

(21) Appl. No.: 15/692,817

(22) Filed: Aug. 31, 2017

Related U.S. Application Data
(60) Provisional application No. 62/399,076, filed on Sep. 23, 2016.

(51) Int. Cl. B65D 55/02; E05B 43/00; E05B 65/52

(52) U.S. Cl. CPC B65D 55/02; E05B 65/52; E05B 43/005

(57) ABSTRACT

A locking case for electronic devices may provide for a housing defining at least one cavity configured to removably receive an electronic device and at least one transparent lid configured to removably seal the cavity. In some embodiments, the present invention may provide for a screen, an add time button, a subtract button, and a set button, wherein the present invention is configured such that a user is able to manipulate said buttons to instruct a timing mechanism to create a timing schedule, wherein the timing schedule is received and used by a locking mechanism, and wherein the locking mechanism may lock the lid against the housing for a specified amount of time per the timing schedule.

### CROSS-REFERENCE TO RELATED APPLICATION

This application claims priority to U.S. Provisional Application No. 62/399076 filed on Sep. 23, 2016, the disclosure of which, including any materials incorporated by reference therein, is incorporated herein by reference in its entirety.

### TECHNICAL FIELD

The present invention relates generally to device cases, and more specifically to a case for an electronic device, wherein the case has a timed locking mechanism.

### BACKGROUND

Currently there are a number of solutions for taking a technology break from cellphones and electronic devices. A user may simply put away his or her phone, in an attempt to free up time and take a break from emails, texts and phone calls, but this solution fails because it relies on the person's willpower alone to keep the user from succumbing to the device. Another solution attempts to physically lock the device away, but this solution is similarly unable to meet the needs of the user because the user worries they are missing an important message. What is needed therefore is a middle ground: a protective case that temporarily locks the person's phone.

Various attempts to solve this problem have been made. One such attempt can be seen with respect to U.S. Pat. No. 8,584,847, incorporated by reference in its entirety herein, which generally discloses a mobile device case having corner protection features. While this disclosure does provide for a useful case, it fails to provide for a timed-lock feature.

Another attempt can be seen with respect to U.S. Pat. No. D745506S1, incorporated by reference in its entirety herein, which generally discloses a mobile device case with advanced protection features. While this disclosure does provide for a sturdy case, it also fails to provide for a timed-lock feature.

Yet another attempt can be seen with respect to U.S. Patent Application Publication No. 2012/0182678, incorporated by reference in its entirety herein, which generally discloses a slim protective mobile case. While this disclosure does provide for a sleek case, it also fails to provide for a timed-lock feature.

Various attempts have been made to solve the problems which may be found in the related art but have thus far been unsuccessful. A need exists for a temporarily-locking mobile device case that enables a user to take a break from the device, in addition to other features.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a back plate, screen protector, etc., are herein meant to include or encompass all equivalents for such elements. For example, in addition to a “back plate”, any portion of a case that serves as the rear portion is also contemplated by the present invention. Such equivalents are contemplated for each element named in its particular herein.

The present invention relates to a mobile device case that overcomes the deficiencies of the prior art. It is contemplated that the present invention may provide a mobile device case having a timed locking mechanism.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

The features of the invention which are believed to be novel are particularly pointed out and distinctly claimed in the concluding portion of the specification. These and other features, aspects, and advantages of the present invention will become better understood with reference to the following drawings and detailed description.

In embodiments, a locking case for electronic devices may comprise a housing defining a cavity for the placement of an electronic device. The cavity of the housing may be reduced in size through a sliding mechanism that incorporates a movable rail element, wherein the movable rail may be positioned such that the movable rail shrinks or enlarges the size of the cavity so as to precisely accommodate an electronic device. The present invention may also provide for a lid hingedly connected to the housing, in some embodiments removably connected to the housing, that may alternate between an open and a closed position. The lid, in some embodiments, may be partially transparent. In some embodiments, the lid may be transparent. The housing may further provide for a lock mechanism configured to, when in the locked position, prevent the lid from moving into the open position. The housing may provide for at least one timing mechanism that may comprise elements such as but not limited to a screen, a set button, an on/off button, a door open/door close button, an add time button, and a subtract time button, wherein the above buttons are configured to adjust the duration and manner in which the lock mechanism is in the locked position. The housing may further provide for an aperture configured to allow a charging cable to pass through the aperture.

In some embodiments, the lock may be activated by a user, wherein the timing mechanism may cause the locking mechanism to lock the lid in the locked position for a set period of time so as to restrict a user's access to an electronic device placed within the housing. Because the lid may be generally transparent, a user may still see the screen of an enclosed electronic device when the locking mechanism is in the locked position. In some embodiments, the lock mechanism may be accessible to a user via a button or interface on the housing. In other embodiments, the locking mechanism may be contained within the housing.

In some embodiments, the locking mechanism may be located within the housing, whether fixedly connected to the housing or removably contained within it. In some embodiments, the timing mechanism may be located within the housing, whether fixedly connected to the housing or removably contained within it. In some embodiments, the timing mechanism may be configured to receive instructions through the present invention's buttons and generate a timing schedule (or “timing instruction”) from the instructions, and may be configured to transmit the timing schedule to the locking mechanism. In turn, the locking mechanism may be configured to receive and interpret the timing schedule, and may then lock the lid in place for a duration set by the timing schedule.

In some embodiments, the timing schedule may be displayed as a countdown timer on the screen. In some embodiments, the screen may not show the remaining time wherein the lid may be locked against the housing. In some embodiments, the present invention may provide that the screen displays a message such as “locked” or “go play outside” or any other message.

The unique features of the present invention may provide the following benefits for one or more consumers: it may provide a mobile case for electronic devices with a timed lock mechanism, which in turn provides an enforced break from electronic devices. It also may provide for a protective case for a mobile phone, large mobile phone, or tablet.

### BRIEF DESCRIPTION OF THE DRAWINGS

These and other features, aspects and advantages of the present invention will become better understood with regard to the following description, appended claims, and accompanying figures where:

FIG. 1 shows a perspective view of a locking case for electronic devices in accordance with one embodiment of the invention.

FIG. 2 shows a perspective view of a locking case for electronic devices in the open position in accordance with one embodiment of the invention.

FIG. 3 shows a side view of a locking case for electronic devices in the open position in accordance with one embodiment of the invention.

FIG. 4 shows a top-perspective view of a locking case for electronic devices in accordance with one embodiment of the invention.

FIG. 5 shows a side-perspective view of a locking case for electronic devices in accordance with one embodiment of the invention.

FIG. 6 shows a close-up perspective view of a locking case for electronic devices in accordance with one embodiment of the invention.

FIG. 7 shows a top-plan view of a locking case for electronic devices in accordance with one embodiment of the invention.

FIG. 8 shows a top-plan view of several elements of a timing mechanism of a locking case for electronic devices in accordance with one embodiment of the invention.

FIG. 9 shows a side view of a locking case for electronic devices in accordance with one embodiment of the invention.

FIG. 10 shows several views of a locking case for electronic devices in accordance with at least one embodiment of the invention.

### DETAILED DESCRIPTION

The present invention overcomes the limitations of the prior art by providing a new and more effective locking case for electronic devices.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element is first numbered.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well known features, elements or techniques may not be shown in detail in order not to obscure the embodiments.

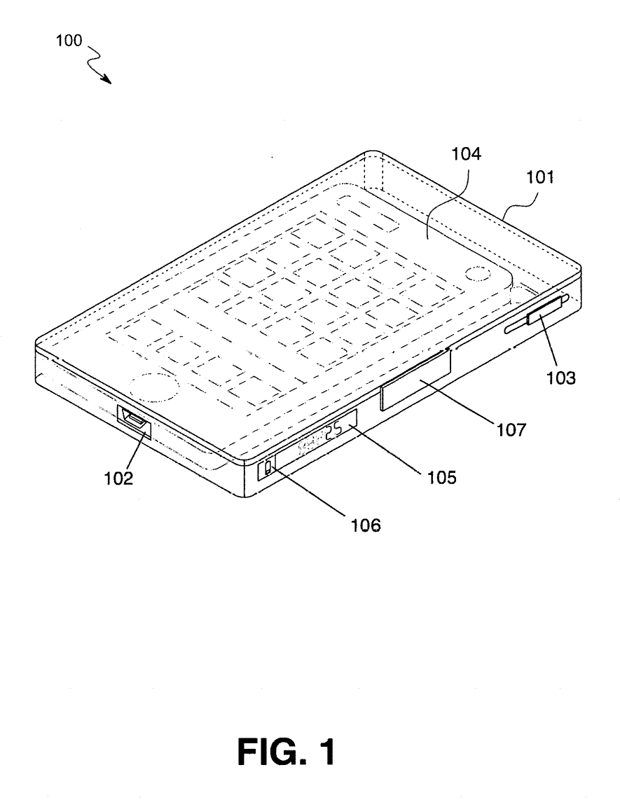

Turning attention to FIG. 1, a perspective view of a locking case for electronic devices in accordance with one embodiment of the invention is shown. In the embodiment depicted, a viewer may perceive locking case for electronic device 100, housing 101, aperture 102, sliding mechanism 103, electronic device 104, side screen 105, battery indicator 106, and latch 107.

As may be seen in other Figures, the elements disclosed in FIG. 1 are contemplated to take several different configurations, as the embodiments demand. For example, in the embodiment depicted in FIG. 1, housing 101 is configured to provide for side screen 105, battery indicator 106, and latch 107 on the side of housing 101, whereas these elements are not visible, and in some embodiments not present, in other embodiments depicted herein. It is contemplated that housing 101 may be plastic, metal, elastomer, ceramic, carbon fiber, or fabric, a combination of plastic, metal, elastomer, ceramic, carbon fiber, or fabric, or any other element or combination of comparable elements known in the art. Housing 101 may also be larger or smaller to accommodate any size or type of electronic device 104.

Aperture 102 may be of any size or configuration known in the art to enable a cable to pass through. In some embodiments, the present invention may provide for two or more apertures 102. In some embodiments, aperture 102 may be covered by a removable cover (not shown).

In some embodiments, sliding mechanism 103 may be manually movable by a user. In some embodiments, the present invention may provide for one or more mechanical means for movement wherein the present invention may detect the dimensions of electronic device 104 and may adjust sliding mechanism 103 automatically or semi-automatically.

In some embodiments, side screen 105 and battery indicator 106 may be configured to provide the user with information, such as but not limited to, the battery life of the device and the duration (if any) in which the lock mechanism is or will be in the locked position. In some embodiments, battery indicator 106 may be represented as a series of lights.

It is contemplated that any electronic device 104 may encompass a mobile phone, a large mobile phone (a “phablet”), a tablet, a laptop, a PDA, a pager, a desktop computer. In some embodiments, electronic device 104 may also encompass a non-electronic device such as a book, an easel, or any object of interest.

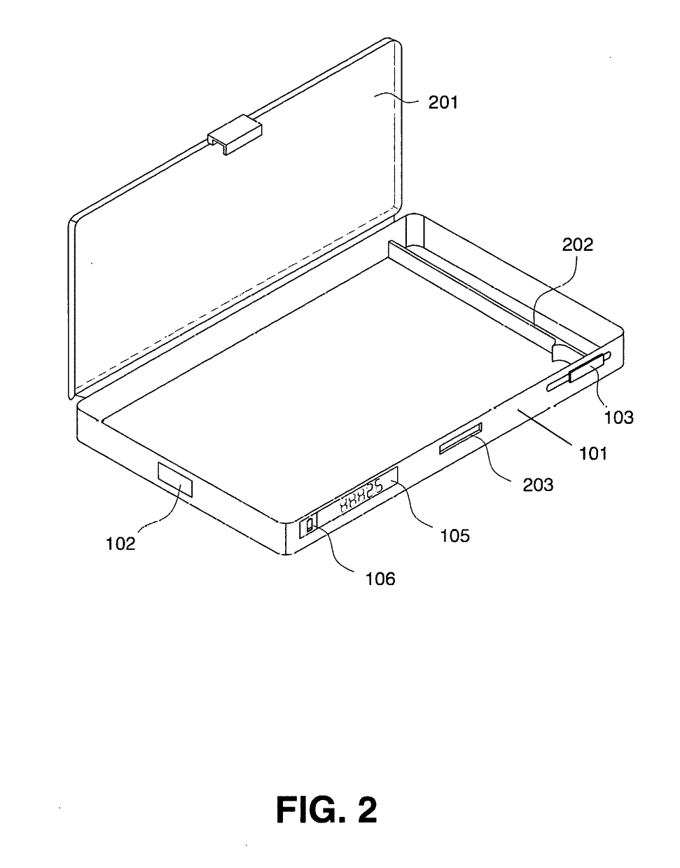

With respect to FIG. 2, a perspective view of a locking case for electronic devices in the open position in accordance with one embodiment of the invention is shown. In the embodiment depicted, a viewer may perceive lid 201, movable rail 202, and cavity for latch 203, along with housing 101, aperture 102, sliding mechanism 103, side screen 105, and battery indicator 106.

It is contemplated that in many embodiments, lid 201 may be transparent.

In some embodiments, however, lid 201 may be partially transparent. Lid 201 may take any thickness or shape known in the art as necessary. Additionally, lid 201 may be made of plastic glass, silicate glass, a bioplastic, or any plastic known in the art.

In the embodiment shown in FIG. 2, movable rail 202 is shown as configured to span part of the area in which an electronic device 104 may be placed. However, in some embodiments, movable rail 202 may be longer, shorter, thicker, thinner, or generally of any practicable shape in addition to or in substitution for the embodiment of movable rail 202 shown in FIG. 2. Movable rail 202, in some embodiments, may not be substantially straight as depicted in FIG. 2, but may be curved or of any shape practicable with the present invention. In the embodiment shown in FIG. 2 and in other Figures, movable rail 202 is depicted as moving in a “top-down” manner, but may be configured to move in any direction.

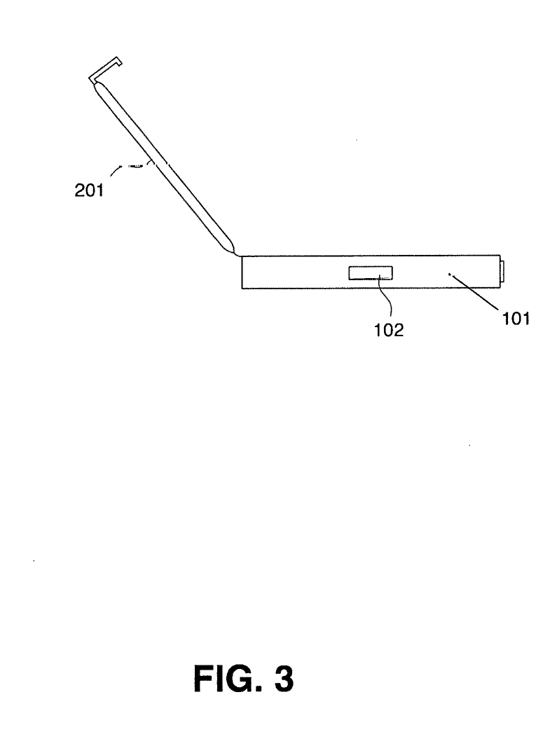

With respect to FIG. 3, a side view of a locking case for electronic devices in the open position in accordance with one embodiment of the invention is shown. In the embodiment depicted, a viewer may perceive housing 101, aperture 102, and lid 201.

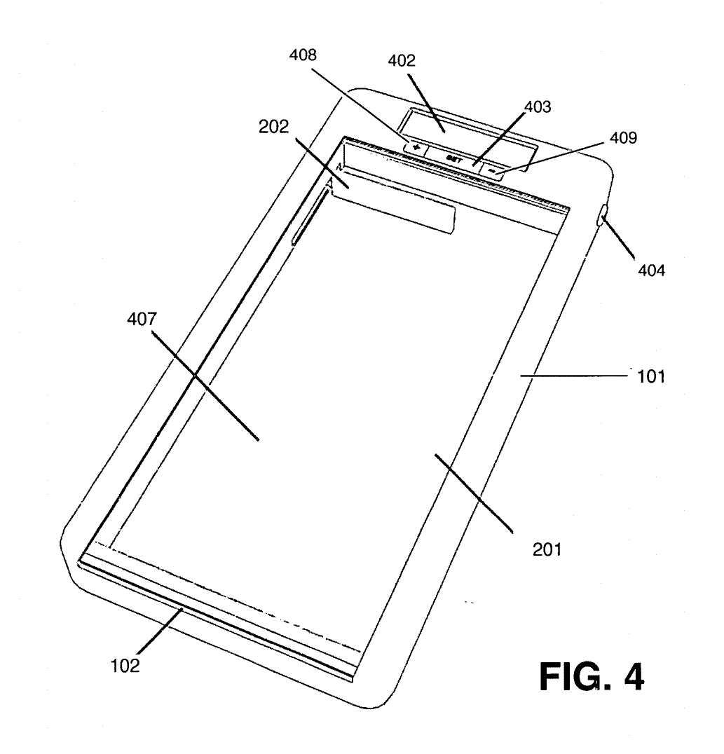

With respect to FIG. 4, a top-perspective view of a locking case for electronic devices in accordance with one embodiment of the invention is shown. In the embodiment depicted, a viewer may perceive screen 402, set button 403, on/off button 404, area in which to place device 407, add time button 408, and subtract time button 409, along with lid 201, movable rail 202, aperture 102, and housing 101.

It is contemplated that, in some embodiments, a user may press add time button 408 and subtract time button 409 until a desired lock time is achieved, then press set button 403. In some embodiments, the time, success or failure of the timed lock function, and other information may be displayed on screen 402. In some embodiments, screen 402, set button 403, add time button 408, and subtract time button 409 may be arranged in any configuration on housing 101, including on one or more additional or alternate sides of housing 101.

In some embodiments, a timing mechanism (not shown) may comprise but is not limited to the elements of screen 402, set button 403, add time button 408, and subtract time button 409. In some embodiments, the timing mechanism may be communicatively linked with the locking mechanism (also not shown, both located within housing 101) such that, when a user has manipulated screen 402, set button 403, add time button 408, and subtract time button 409 as described and has set a time for locking, timing mechanism may cause locking mechanism to lock lid 201 in place for the duration of the time for locking.

In some embodiments, screen 402, set button 403, add time button 408, subtract time button 409, and in some embodiments one or more additional elements, may be used to turn off or otherwise override the timed lock feature of the present invention when needed, such as but not limited to, in an emergency.

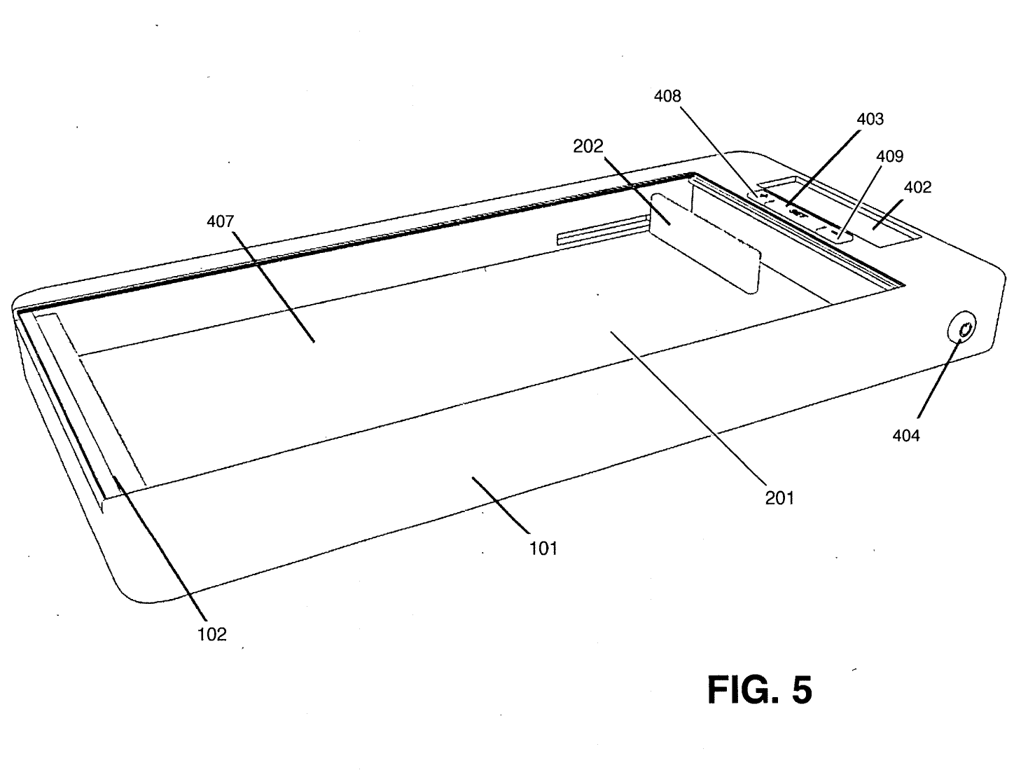

Turning attention to FIG. 5, a side-perspective view of a locking case for electronic devices in accordance with one embodiment of the invention is shown. In the embodiment depicted, a viewer may perceive housing 101, aperture 102, screen 402, lid 201, movable rail 202, set button 403, on/off button 404, area in which to place device 407, add time button 408, and subtract time button 409.

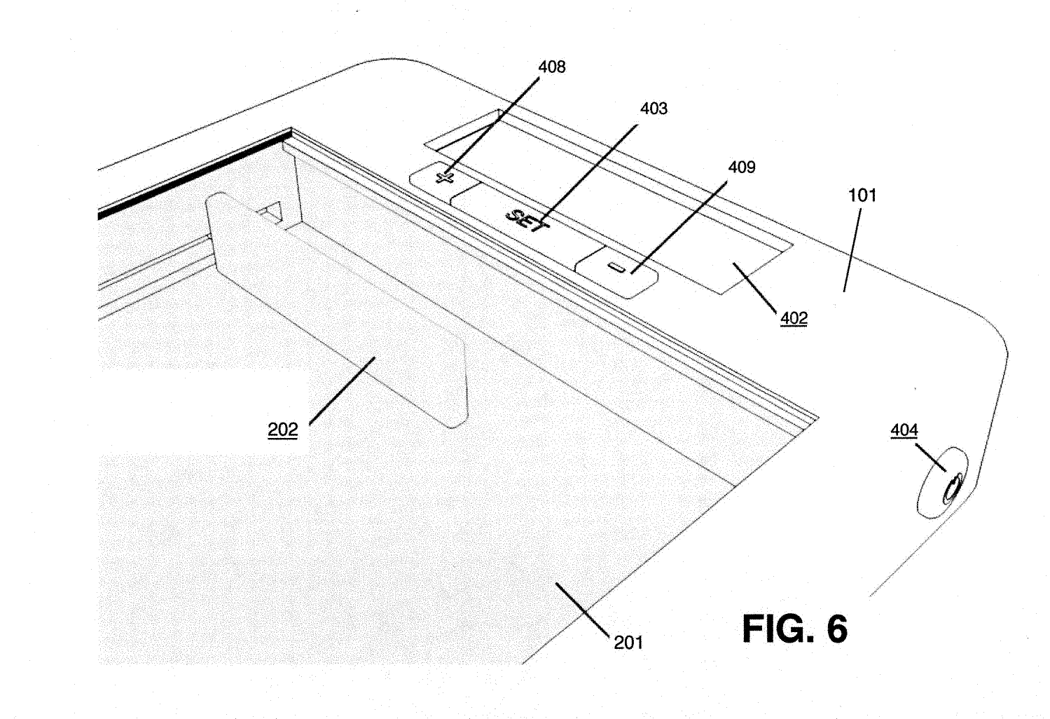

With respect to FIG. 6, a close-up perspective view of a locking case for electronic devices in accordance with one embodiment of the invention is shown. In the embodiment depicted, a viewer may perceive housing 101, lid 201, movable rail 202, screen 402, set button 403, on/off button 404, add time button 408, and subtract time button 409.

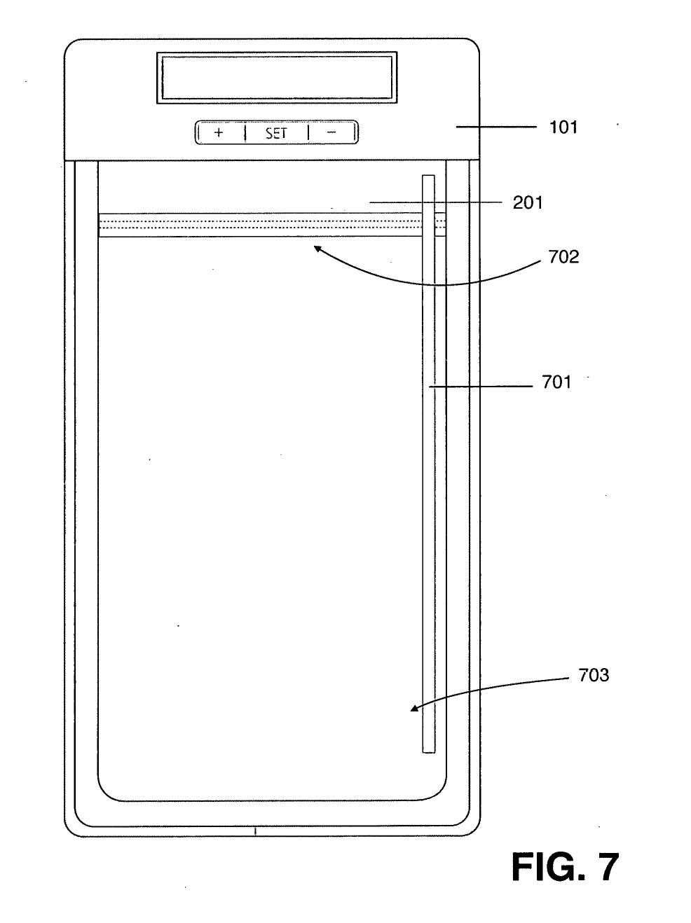

Turning attention to FIG. 7, a top-plan view of a locking case for electronic devices in accordance with one embodiment of the invention is shown. In the embodiment depicted, a viewer may perceive movable rail 701, central plane of rail movement 702, and direction of rail movement 703, along with housing 101, and lid 201.

In the embodiment depicted in FIG. 7, an embodiment of the present invention is shown wherein movable rail 701 may move side to side, instead of or in combination with its top-down movement as shown in other Figures herein.

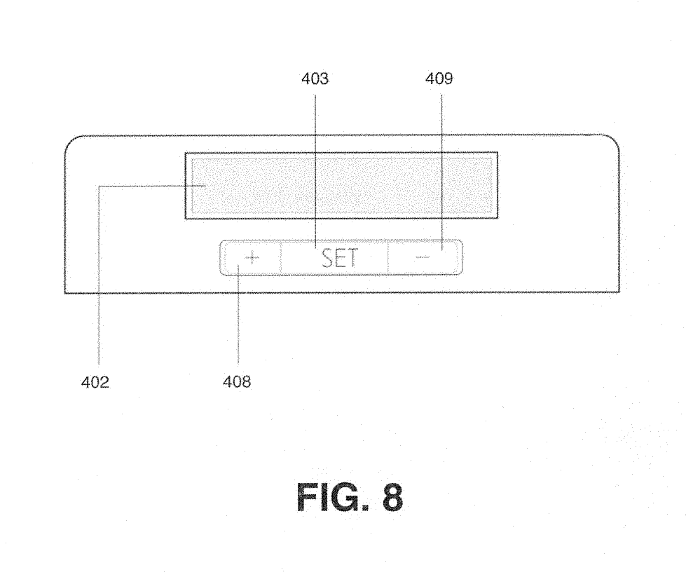

With respect to FIG. 8, a top-plan view of several elements of a timing mechanism of a locking case for electronic devices in accordance with one embodiment of the invention is shown. In the embodiment depicted, a viewer may perceive screen 402, set button 403, add time button 408, and subtract time button 409.

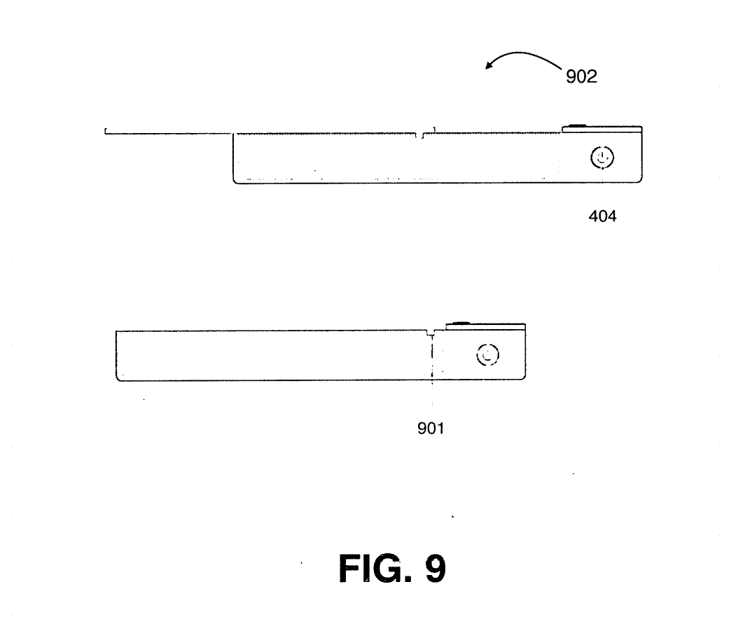

Turning attention to FIG. 9, a side view of a locking case for electronic devices in accordance with one embodiment of the invention is shown. In the embodiment depicted, a viewer may perceive simple stop mechanism 901, and direction of lid movement 902, along with on/off button 404.

The embodiment depicted in FIG. 9 generally shows a sliding lid 201 (not labeled in FIG. 9) that may travel along the face of housing 101 and may be removably held in place by simple stop mechanism 901.

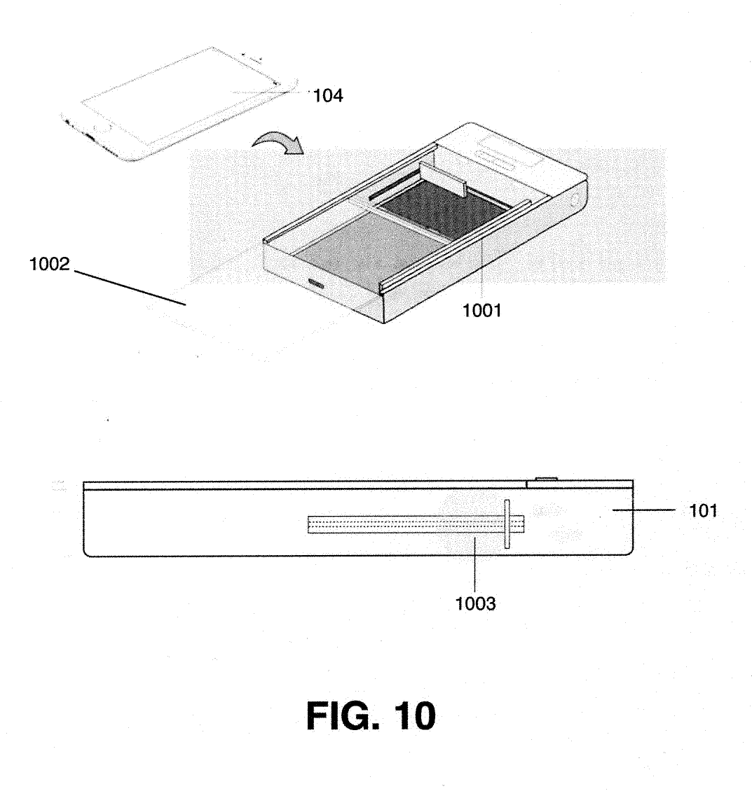

With respect to FIG. 10, several views of a locking case for electronic devices in accordance with at least one embodiment of the invention are shown. In the views depicted, a viewer may perceive guiding edge 1001, lid 1002, and sliding mechanism 1003, along with electronic device 104.

The embodiment depicted in FIG. 10 generally shows a raised guiding edge 1001, along with lid 1002, wherein lid 1002 may be configured to slide within guiding edge 1001. In some embodiments, guiding edge 1001 may not be raised and may be located within housing 101.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the locking case for electronic devices as generally described herein has been disclosed in connection with a number of embodiments shown and described in detail, various modifications should be readily apparent to those of skill in the art.

What is claimed is:

1. A case for a device, comprising:
a housing having an upper portion, a lower portion, at least one side portion, a front side and a back side, wherein the housing defines at least one first cavity configured to receive at least one device, and wherein the housing defines at least one aperture configured to allow at least one cable to pass through the at least one aperture;
at least one screen fixedly connected to the housing;
at least one button fixedly connected to the housing, wherein the at least one button is configured to transmit at least one data element;
at least one lid, wherein the at least one lid is configured to seal the at least one first cavity;
at least one movable rail;
at least one timing mechanism contained within and connected to the housing, wherein the at least one timing mechanism is communicatively linked to the at least one button, and wherein the at least one timing mechanism is configured to receive at least one data element from the at least one button, and wherein the at least one timing mechanism is configured to generate at least one timing schedule based on at least one data element received from the at least one button; and
at least one locking mechanism contained within and connected to the housing, wherein the at least one locking mechanism is communicatively linked to the at least one timing mechanism, and wherein the at least one locking mechanism is configured to receive the at least one timing schedule, and wherein the at least one locking mechanism is configured to lock the at least one lid against the housing according to the at least one timing schedule.

2. The case of claim 1, wherein the at least one lid is transparent.

3. The case of claim 1, wherein the at least one device is at least one mobile phone.

4. The case of claim 1, wherein the at least one device is at least one large mobile phone.

5. The case of claim 1, wherein the at least one device is at least one tablet.

6. The case of claim 1, wherein the at least one button is at least one add time button, at least one set button, and at least one subtract time button.

7. The case of claim 6, wherein the at least one screen, the at least one add time button, the at least one set button, and the at least one subtract time button are fixedly connected to the housing front side upper portion.

8. The case of claim 1, wherein the at least one first cavity opens to the housing front side.

9. The case of claim 1, wherein the at least one lid is hingedly connected to the housing.

10. The case of claim 1, further comprising at least one guided edge element, and wherein the at least one lid is configured to slide within the at least one guided edge element.

11. The case of claim 1, further comprising an on/off button fixedly connected to the housing.

12. A personal electronic locking device, as is herein shown and described.

13. A personal electronic locking device, the device having a transparent lid and a locking mechanism, wherein access to the personal electronic device is restricted for a designated period of time, as is herein shown and described.
